(19) United States
(12) Patent Application Publication
(10) Pub. No.: US 2026/0201917 A1
(43) Pub. Date: Jul. 16, 2026

(54) Removable Grommet

(71) Applicant: Illinois Tool Works Inc., Glenview, IL (US)

(72) Inventor: Daniel D. Carlson, Hancock, MI (US)

(21) Appl. No.: 19/408,198

(22) Filed: Dec. 3, 2025

Related U.S. Application Data
(60) Provisional application No. 63/728,243, filed on Dec. 5, 2024.

(51) Int. Cl. F16B 5/06

(52) U.S. Cl. CPC F16B 5/0628; F16B 2005/0671

(57) ABSTRACT

A multi-piece grommet assembly for securing a first component to a second component is disclosed. The assembly includes a first grommet body with a flange and a first body portion, and a second grommet body configured for snap-fit engagement with the first grommet body. The grommet bodies are rotatable relative to one another between an unlocked position and a locked position via aligned and misaligned detents, wherein the misaligned detents prevent axial removal of the assembly. One or more retaining snaps extend outwardly from the first grommet body to engage the second component. The assembly further includes a central bore configured to receive a fastener, and a tool-engageable portion on the second grommet body to permit rotation with a torque-applying tool. In certain embodiments, access slots and grip tabs facilitate lateral tool insertion for collapsing the retaining snaps during removal. The grommet bodies can be manufactured from polymeric, metallic, or composite materials using injection molding, additive manufacturing, or other suitable fabrication techniques.

### CROSS-REFERENCE

The present application claims priority to U.S. Provisional Ser. No. 63/728,243 , filed Dec. 5, 2024, and entitled “Removable Grommet” which is hereby incorporated by reference in its entirety.

### BACKGROUND

Automotive components require fastening techniques that are simple to manufacture and assemble. Further, fastening techniques should be reliable and efficient. One example fastening assembly employs grommets and panel-mount hardware, which can be used in various applications. For example, grommets and panel-mount hardware can be employed wherever a fastener must pass through a panel or whenever a reinforced opening is desired for securing a first component 110.

Traditional grommets are frequently manufactured as one-piece elements, requiring deformation or compression for installation and often lacking the ability to be repositioned or removed without damaging the panel or the grommet. Multi-piece grommet systems exist, but many rely on irreversible locking mechanisms, barbs, or deformable wings that prevent controlled rotation between functional states.

In many applications, it is desirable to provide a grommet that may be inserted through a panel opening in one orientation and then selectively rotated into a locked state in which radially projecting features prevent withdrawal. This improves ease of installation, allows for reusability, and enables neat integration of a separate fastener through the grommet bore to secure an overlying or adjoining component. Such systems are especially advantageous when the grommet must be installed into the panel at a manufacturing stage and later receive a screw at assembly, or when overhead or blind installations must be performed. There is accordingly a need for a removable grommet assembly having two components.

### SUMMARY

The present disclosure relates generally to a fastening assembly to form a connection between two components, such as automotive components and panels, substantially as illustrated by and described in connection with at least one of the figures, as set forth more completely in the claims. In some examples, a fastener assembly employs a two-piece grommet and a screw (or other threaded fastener) to couple two or more components to one another.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a side-elevation view of an example fastener system that includes a fastening assembly in accordance with one aspect of this disclosure.

FIGS. 1b and 1c illustrate side-elevation views of the fastening assembly in a locked position and an unlocked position, respectively.

FIGS. 1d and 1e illustrate topside perspective views of the fastening assembly in the locked and unlocked positions, and FIGS. 1f and 1g illustrate corresponding underside perspective views.

FIG. 2a illustrates a top-side perspective view of the fastening assembly in the unlocked position.

FIG. 2b illustrates an underside perspective view of the assembly in the unlocked position, and FIG. 2c provides a top-side isometric view of the assembly in the same state.

FIG. 3 illustrates a perspective view of a tool configured to remove the fastening assembly from an opening in a first component.

FIGS. 4a and 4b illustrate perspective views of the tool during removal of the fastening assembly, while FIGS. 4c through 4e illustrate cross-sectional side-elevation views depicting this removal process.

FIG. 5 illustrates a top plan view of another tool configured to remove the fastening assembly from an opening in a first component.

FIGS. 6a and 6b illustrate underside perspective views of this tool without the fastening assembly attached and with the fastening assembly attached, respectively.

FIGS. 7a and 7b illustrate top-side perspective views of the fastening assembly in disassembled and assembled configurations.

FIGS. 7c and 7d illustrate corresponding side-elevation views.

FIGS. 7e and 7f illustrate top and bottom plan views.

FIGS. 7g and 7h show cross-sectional views taken along cutlines A-A and B-B of FIG. 7b.

FIGS. 7i and 7j illustrate perspective and top plan cross-sectional views taken along cutlines E-E of FIG. 7c.

FIG. 8a illustrates an isometric assembled view of a fastening assembly in accordance with another aspect of this disclosure, and FIG. 8b provides an additional assembled perspective view.

FIGS. 9a and 9b illustrate top-side perspective views of another fastening-assembly embodiment in disassembled and assembled positions.

FIGS. 9c and 9d illustrate side-elevation views in these positions, FIGS. 9e and 9f show top and bottom plan views, and FIGS. 9g and 9h illustrate cross-sectional views taken along cutlines C-C and D-D of FIG. 9b.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

As explained, there is a need for a removable grommet assembly having two bodies or components that may be snap-fit together, remain rotatable relative to one another, present different radial profiles depending on rotational alignment, and provide a through-bore capable of receiving a fastener. To that end, disclosed is a fastener assembly configured to form a connection between a first component and a second component via, for example, a threaded fastener (e.g., a screw). The disclosed fastener assembly will be described primarily as a multi-piece grommet assembly having a first grommet body and a second grommet body.

As will be described, the first grommet body and the second grommet body may be secured to one another through a combination of retaining legs and a quarter turn rotation (i.e., a 90-degree rotation). The disclosed fastener system allows for pre-installation of the multi-piece grommet assembly in a component (e.g., a panel) as a part-in-assembly (“PIA”) prior to shipment. Preinstalling one or more components offers certain benefits, such as reducing operations required on the assembly line.

In one example, a multi-piece grommet assembly for securing a first component to a second component comprises: a first grommet body comprising a flange configured to abut a surface of the second component and a first body portion extending axially from the flange; a second grommet body comprising a second body portion configured for snap-fit engagement with the first grommet body, wherein the first and second grommet bodies are rotatable relative to one another about a center axis between a first position and a second position; a plurality of slots disposed on the first grommet body and a plurality of tabs disposed on the second grommet body, wherein the slots and tabs align in the first position and are misaligned in the second position to prevent axial removal of the multi-piece grommet assembly; one or more retaining snaps extending outwardly from the first body portion and configured to engage the second component; and a bore extending through the first and second grommet bodies along the center axis, the bore configured to receive a fastener to secure the first component to the second component.

In some examples, the first and second grommet bodies are axially fixed and snap-fit together via an engagement ridge on one grommet body cooperating with an engagement shoulder on the other grommet body.

In some examples, the first grommet body further comprises a plurality of access slots formed in the flange, the access slots configured to receive a tool to collapse the retaining snaps.

In some examples, the multi-piece grommet assembly further comprises grip tabs extending from the retaining snaps toward or into the access slots, the grip tabs configured to provide a positive engagement interface with jaws of a plier-type tool.

In some examples, the grip tabs include a textured portion configured to increase friction between the tool and the retaining snaps during manipulation.

In some examples, the slots and tabs engage via an interference fit in the first position to reduce unwanted rotation between the grommet bodies.

In some examples, the bore comprises a counterbore portion configured to at least partially receive a head portion of the fastener.

In some examples, the first and second grommet bodies are formed of a polymeric material.

In some examples, the polymeric material is a polypropylene, polyethylene, polycarbonate, acrylonitrile butadiene styrene, polyamide, polyoxymethylene, thermoplastic elastomer, or thermoset material.

In some examples, the first and second grommet bodies are injection-molded.

In another example, a multi-piece grommet assembly for securing a first component to a second component comprises: a first grommet body comprising a flange and a first body portion; a second grommet body comprising a second body portion configured for snap-fit engagement with the first grommet body; and a tool-engageable portion on the second grommet body, the tool-engageable portion configured to receive a torque-applying tool to rotate the second grommet body relative to the first grommet body between a first position and a second position, wherein rotation of the second grommet body causes detents on the second grommet body to move between alignment with detents on the first grommet body in the first position to allow axial removal of the multi-piece grommet assembly and a misalignment with detents on the first grommet body in the second position to prevent axial removal of the multi-piece grommet assembly.

In some examples, the tool-engageable portion comprises a linear slot, cruciform slot, square slot, Torx/star slot, or other drive interface.

In some examples, the bore extends through the first and second grommet bodies and is configured to receive a fastener to secure the first component to the second component.

In some examples, the first and second grommet bodies are axially fixed and snap-fit together via an engagement ridge and engagement shoulder.

In yet another example, a multi-piece grommet assembly for securing a first component to a second component comprises: a first grommet body comprising a flange with one or more access slots; a second grommet body configured for snap-fit engagement with the first grommet body; one or more retaining snaps extending from the first grommet body toward the second component; and grip tabs extending upwardly from the retaining snaps toward or into the access slots, the grip tabs including a textured portion configured to engage a jaw of a plier-type tool inserted laterally into the access slots, such that the retaining snaps can be collapsed to permit removal of the multi-piece grommet assembly.

In some examples, the grip tabs comprise raised ridges, knurling, or molded friction-enhancing patterns.

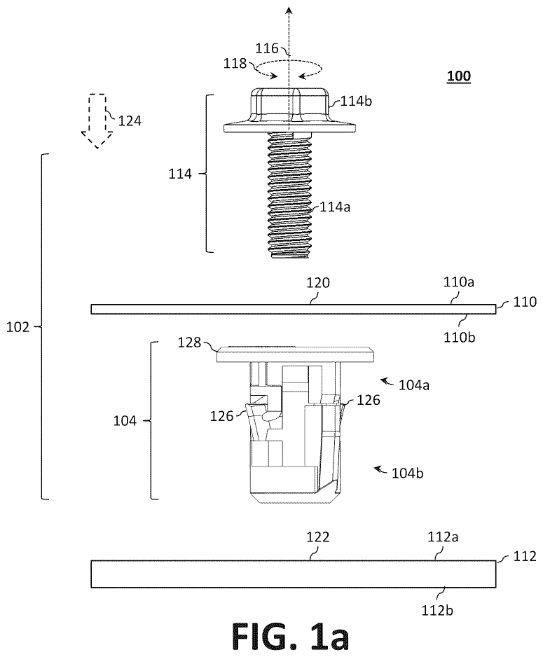

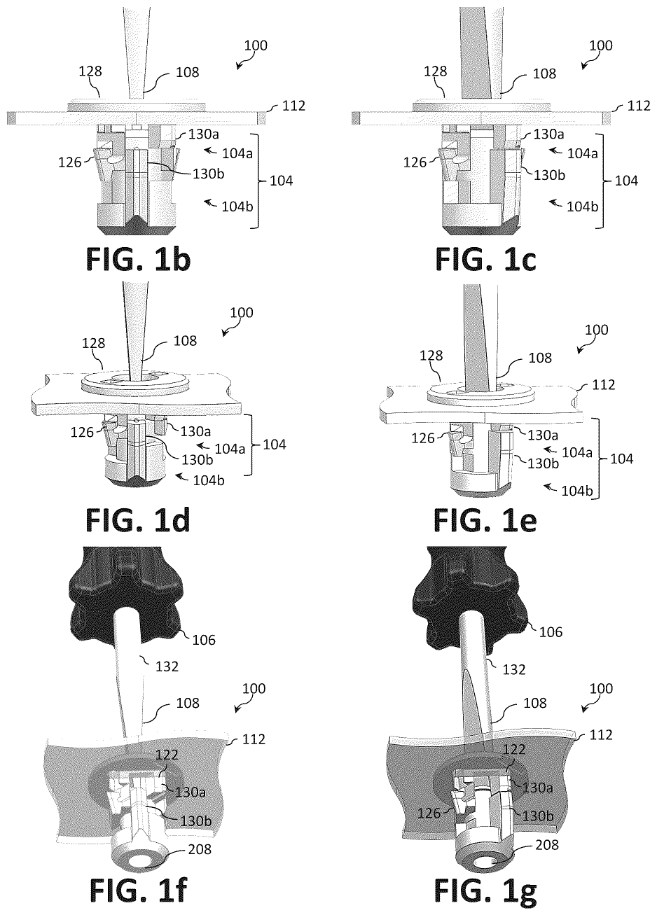

FIG. 1a shows a side-elevation view of an example fastener system 100 that includes a fastening assembly 102 with a multi-piece grommet assembly 104 in accordance with one aspect of this disclosure. FIGS. 1b and 1c show side-elevation views of the fastening assembly 102 with the multi-piece grommet assembly 104 in a locked position and an unlocked position, respectively. FIGS. 1d and 1e provide topside perspective views of the multi-piece grommet assembly 104 in the locked and unlocked positions, and FIGS. 1f and 1g provide corresponding underside perspective views. The multi-piece grommet assembly 104 can be alternated between the locked and unlocked positions via a tool 106, which can include a flat head driver 108.

The example fastener assembly 102 is configured to join a first component 110 and a second component 112 in accordance with aspects of this disclosure. The illustrated fastener assembly 102 includes a multi-piece grommet assembly 104 configured to receive and to secure a fastener 114. As illustrated, the multi-piece grommet assembly 104 comprises a first grommet body 104a and a second grommet body 104b.

As illustrated, the fastener assembly 102 is configured to form a connection between the first component 110 and the second component 112 via a threaded fastener 114. In operation, the first grommet body 104a and the second grommet body 104b are configured to rotate relative to one another (e.g., about a quarter turn—90 degrees) about a center axis 116 to transition between a first position (e.g., unfastened position/unsecured position) and a second position (e.g., fastened position/secured position) as indicated by arrow 118.

The illustrated threaded fastener 114 comprises a shaft 114a and a head portion 114b. The head portion 114b includes an engagement feature formed therein or thereon. In the illustrated example, the engagement feature is illustrated as a hex-shaped head (e.g., to engage a socket wrench), but other shapes and configurations are contemplated, such as a linear slot, a Phillips-style slot, square, star, or the like.

Depending on the application, the first component 110 and the second component 112 may be fabricated from, for example, metal (or a metal alloy), synthetic or semi-synthetic polymers (e.g., plastics, such as acrylonitrile butadiene styrene (ABS) and polyvinyl chloride (PVC)), composite materials (e.g., fiberglass), or a combination thereof. In one example, the first component 110 is an automotive secondary panel and the second component 112 is an automotive primary panel.

The first component 110 may define an A-surface 110a and a B-surface 110b (illustrated as an undersurface). The A-surface 110a, also called a class A surface, is typically the surface that is visible after assembly and, for that reason, is more aesthetically pleasing (e.g., includes a logo, texture, coating, or other decorations) and typically is free of attachment devices and/or related features. Conversely, the B-surface 110b, also called a class B surface, is typically the surface that is not visible after assembly. The second component 112 may likewise define an A-surface 112a and a B-surface 112b (illustrated as an undersurface).

In the automotive industry, example first components 110 include, without limitation, jack covers, trailer hitch covers, door trim panels, moldings, trim pieces, and other substrates (whether used on the interior and exterior surfaces). The second component 112 may be, for example, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like.

The first component 110 includes, defines, or otherwise provides a first opening 120, while the second component 112 includes, defines, or otherwise provides a second opening 122. In one example, a leading end of the multi-piece grommet assembly 104 is inserted into and through the second opening 122 formed in or on a surface of the second component 112 in the direction indicated by arrow 124. Each of the first opening 120 and the second opening 122 is illustrated as a square opening with rounded corners (e.g., a substantially square hole) that corresponds to, or otherwise accommodates for, the size and shape of the first grommet body 104a and/or the second grommet body 104b to receive the multi-piece grommet assembly 104; however, other shapes (e.g., rectangles, circular, stars, triangles, quadrangles, and other polygons) are contemplated based on the size, shape, and dimensions of the first grommet body 104a. The multi-piece grommet assembly 104 can be preinstalled relative to the second component 112 as a PIA where one or more snaps 126 retain the multi-piece grommet assembly 104 on second component 112 with a flange 128 at the A-surface 112a.

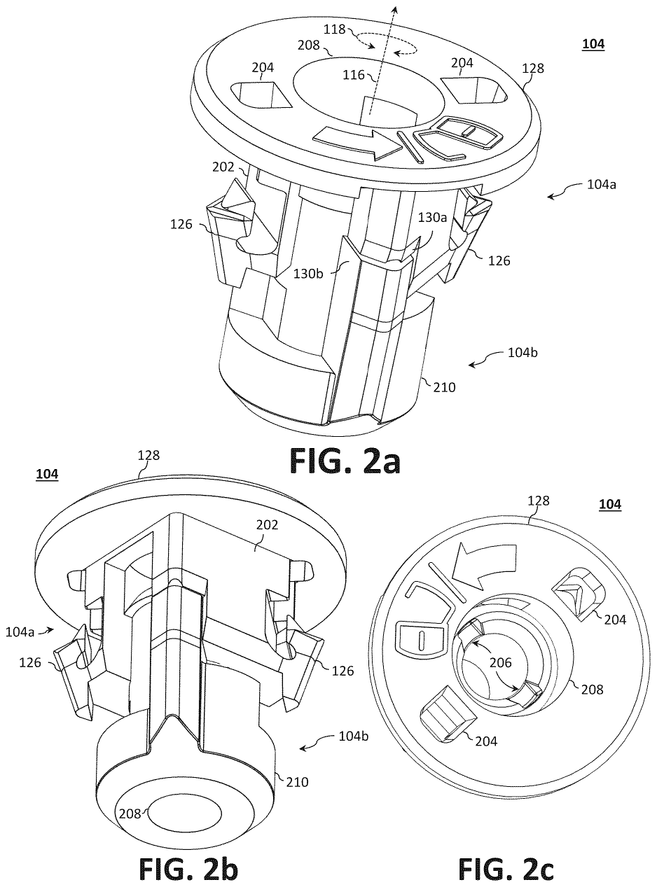

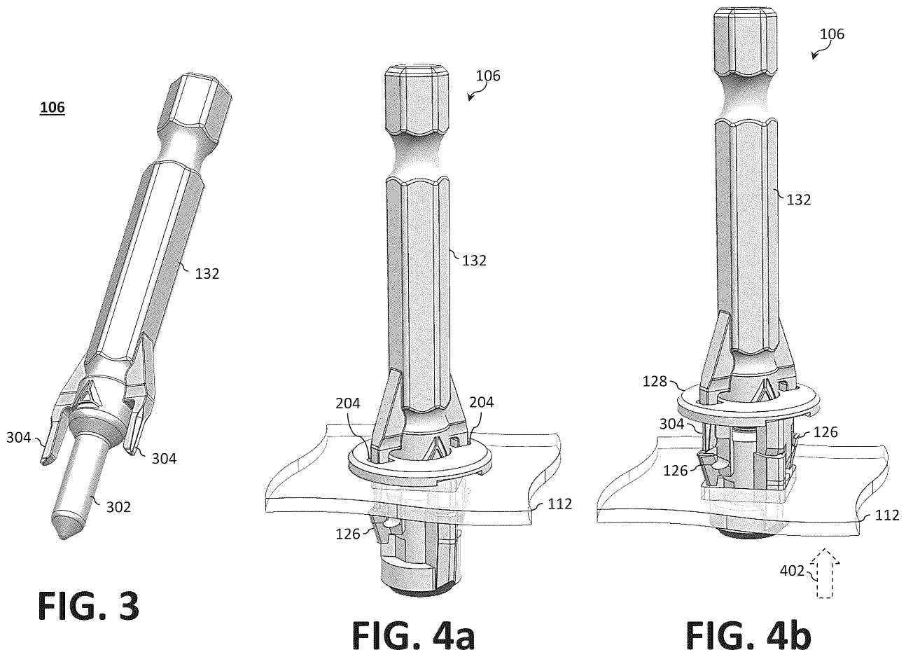

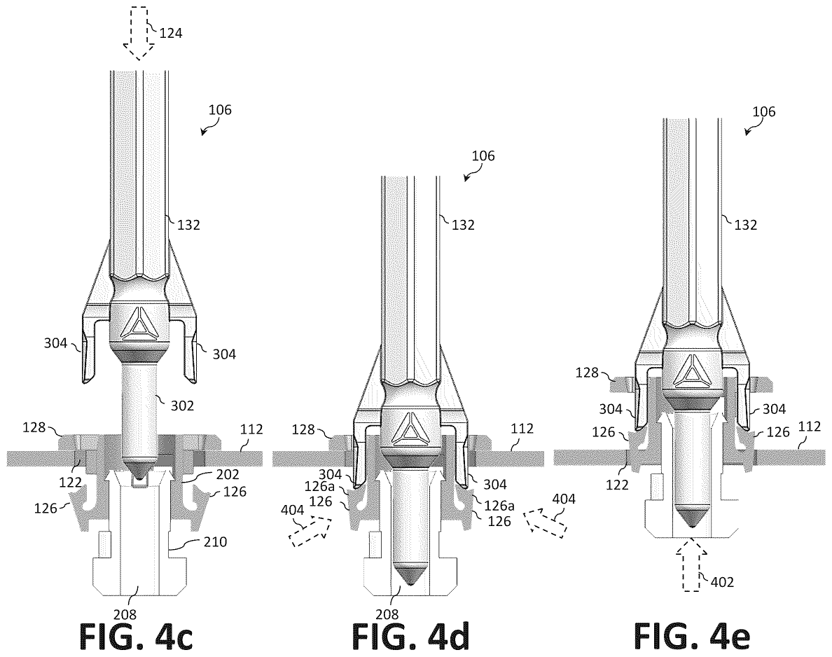

FIG. 2a illustrates a top-side perspective view of the fastening assembly 102 in the unlocked position. FIG. 2b offers an underside perspective view of the fastening assembly 102 in the unlocked position, and FIG. 2c provides a topside isometric view of the fastening assembly 102 in the same state. FIG. 3 illustrates a perspective view of a tool configured to remove the fastening assembly 102 from an opening in a second component 112. FIGS. 4a and 4b illustrate perspective views of the tool during removal of the fastening assembly 102, while FIGS. 4c through 4e provide cross-sectional side-elevation views depicting this removal process.

The first grommet body 104a includes one or more retaining snaps 126 resiliently coupled to and extending outwardly from a sidewall of the body portion 202. The one or more retaining snaps 126 are configured to engage the second component 112 via the second opening 122 (e.g., via the perimeter). Thus, as best illustrated in the cross-sectional views of FIGS. 4c through 4e, the one or more retaining snaps 126 are configured to retain the second component 112 between the one or more retaining snaps 126 and the underside of the flange 128.

The first grommet body 104a and the second grommet body 104b can be made from various materials, including plastics, metals, or a combination of both, depending on the specific application requirements. For example, the multi-piece grommet assembly 104 may be manufactured using a variety of methods including plastic injection molding, extrusion, machining, and additive manufacturing processes such as fused filament fabrication (FFF), selective laser sintering (SLS), stereolithography (SLA), or multi-jet fusion (MJF). Suitable materials include thermoplastics such as polypropylene (PP), polyethylene (PE), polycarbonate (PC), acrylonitrile butadiene styrene (ABS), polyamide (nylon), polyoxymethylene (POM), thermoplastic elastomers (TPE), or thermoset materials depending on required stiffness, resilience, temperature resistance, and fatigue life. Metal-filled polymers, glass-filled polymers, or hybrid composite materials may also be used for higher-strength requirements.

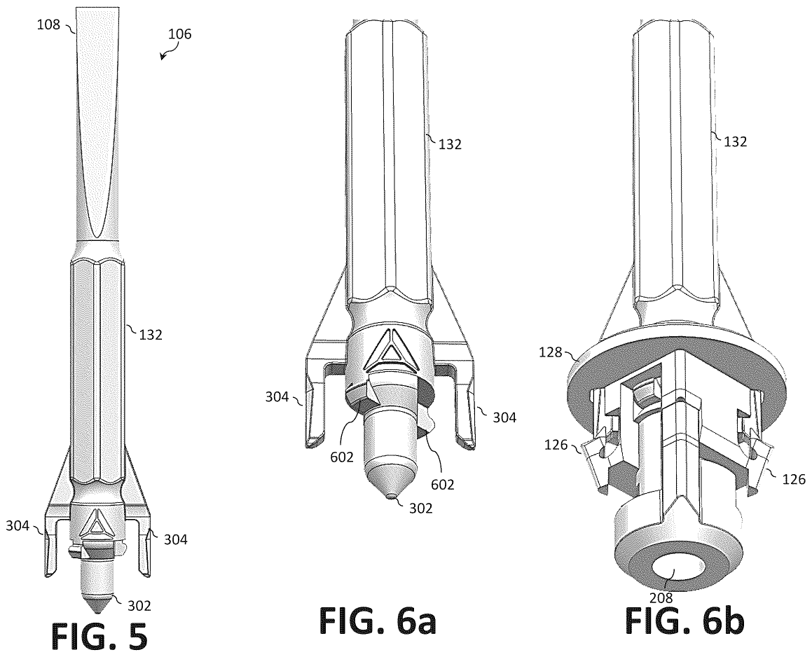

FIG. 5 illustrates a top plan view of another tool 106 configured to remove the multi-piece grommet assembly 104 from an opening in a first component 110. In this example, the tool 106 comprises a flat head driver 108 at one end and the alignment post 302 with the pins 304 at the other end. The tool 106 can also include, adjacent the alignment post 302, a pair of removal tabs 602 to retain the multi-piece grommet assembly 104 for complete removal from the second opening 122.

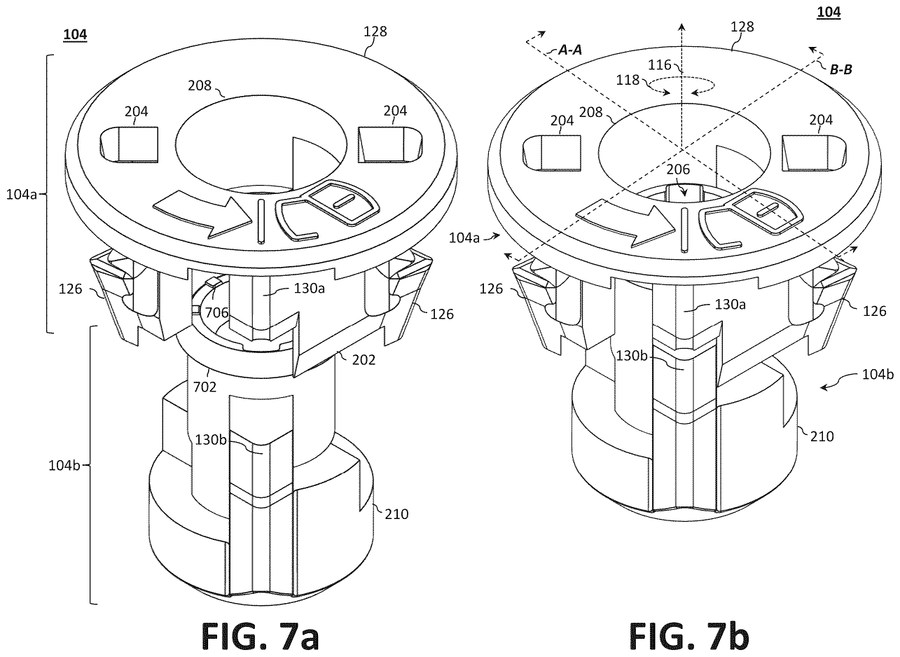

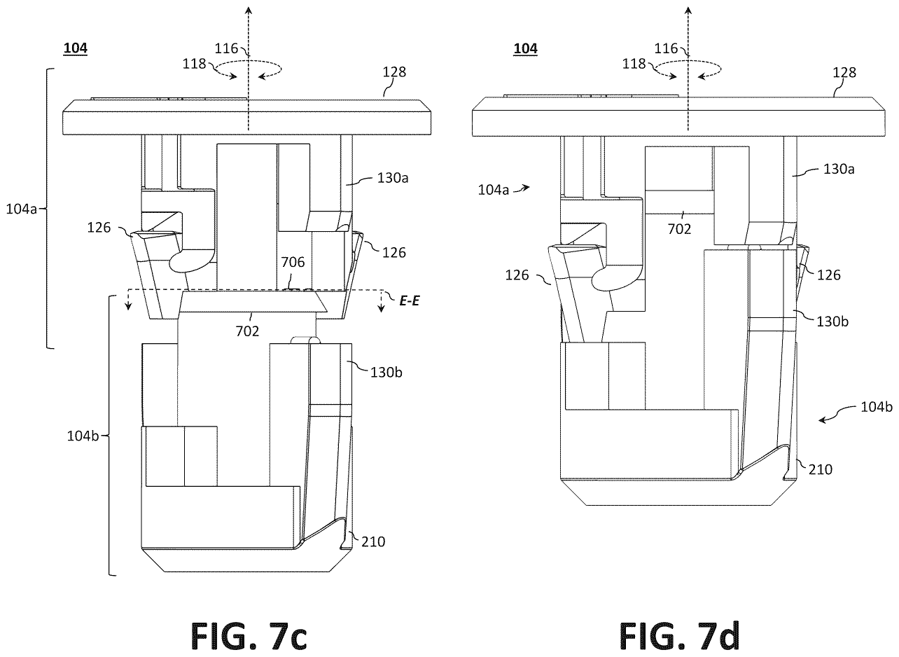

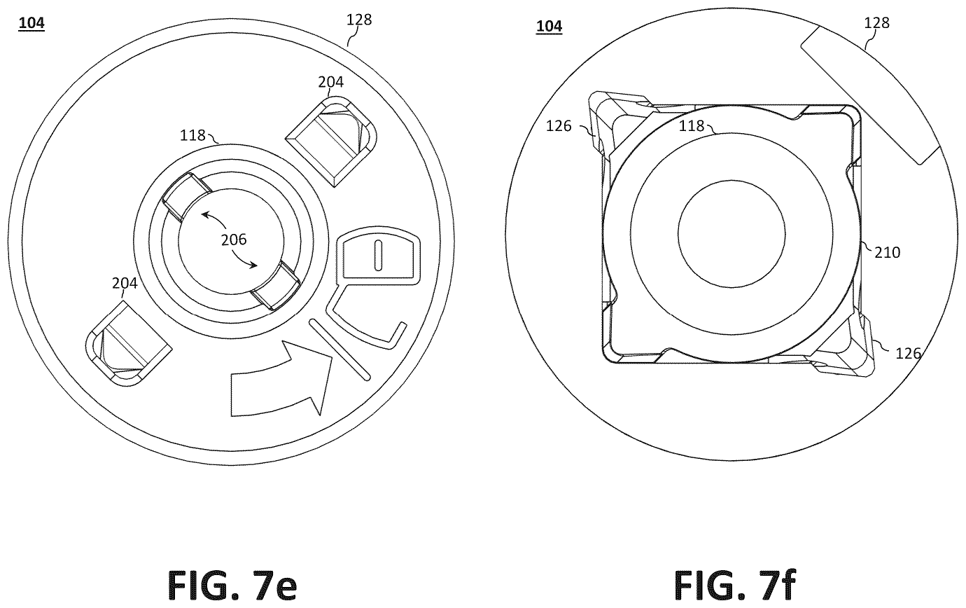

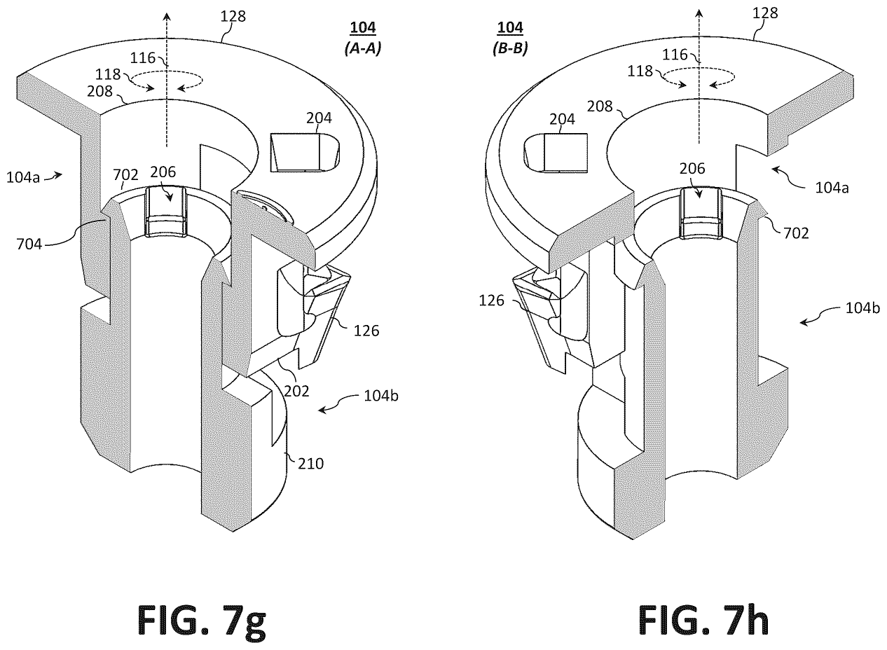

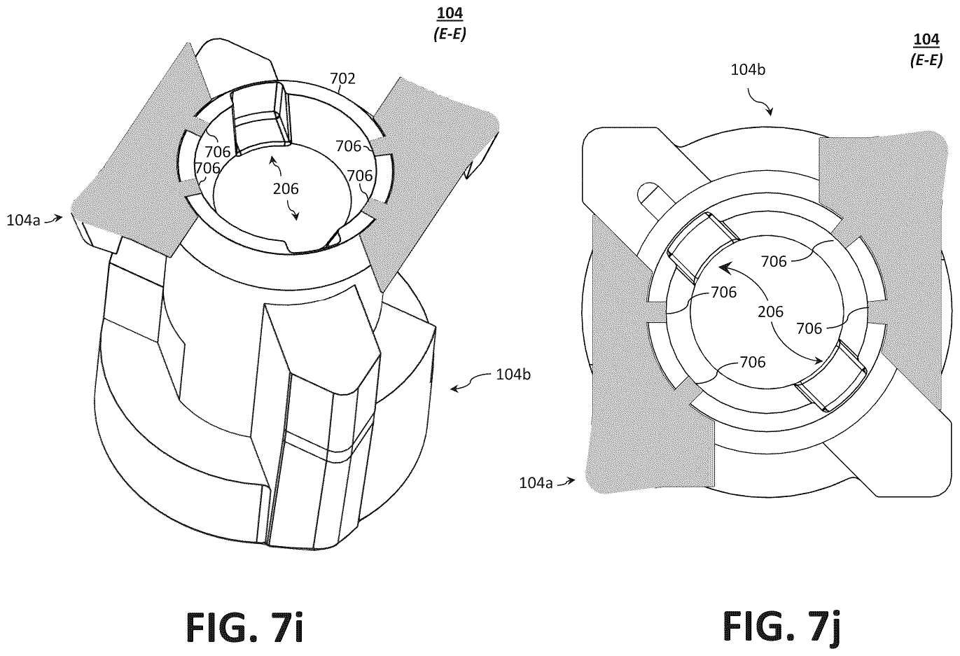

FIGS. 6a and 6b illustrate underside perspective views of this tool 106 without the multi-piece grommet assembly 104 attached and with the multi-piece grommet assembly 104 attached, respectively. FIGS. 7a and 7b illustrate top-side perspective views of the multi-piece grommet assembly 104 in disassembled and assembled configurations. FIGS. 7c and 7d illustrate corresponding side-elevation views. FIGS. 7e and 7f provide top and bottom plan views, and FIGS. 7g and 7h illustrate cross-sectional views taken along cutlines A-A and B-B of FIG. 7b. FIGS. 7i and 7j illustrate perspective and top plan cross-sectional views taken along cutlines E-E of FIG. 7c.

The first grommet body 104a and the second grommet body 104b are configured to be snap-fit into an axially fixed, rotatable relationship. As shown in FIGS. 7i and 7j, the first grommet body 104a and the second grommet body 104b may be molded as a single component and connected to one another by at least one flash-gate connection 706 formed during an injection-molding process. In certain embodiments, a plurality of flash-gate connections 706 are circumferentially spaced around an interface between the first grommet body 104a and the second grommet body 104b. Each flash-gate connection 706 is formed as a thin, intentionally molded, frangible link that allows molten material to flow between the adjoining grommet bodies during molding and solidifies as a narrow connection configured to break upon application of an axial compressive force. During assembly, the first grommet body 104a and the second grommet body 104b can be compressed (pushed toward one another) to fracture the flash-gate connections 706, thereby separating the two bodies, which can then be joined in their intended snap-fit engagement.

The first grommet body 104a includes a flange 128 for abutting one surface of the second component 112 and a body portion 202 extending forward. The body portion 202 includes at least one clearance or recess dimensioned to receive and retain at least a portion of the second grommet body 104b. The body portion 202 further comprises one or more slots 130a and one or more outwardly facing retaining snaps 126. The snaps 126 are configured to allow the multi-piece grommet assembly 104 to be pre-installed in the second component 112 as a PIA.

The second grommet body 104b includes a body portion 210 that comprises one or more tabs 130b that, when in the first position (e.g., unfastened position/unsecured position), align with the one or more slots 130a (e.g., vertically aligned along the center axis 116) and, when rotated to the second position (e.g., fastened position/secured position), are out of alignment (e.g., offset) with the one or more slots 130a. In some examples, when in the first position, the slots and tabs 130a, 130b engage one another via an interference fit to reduce unwanted rotation of the first grommet body 104a and the second grommet body 104b relative to one another, thus preserving the multi-piece grommet assembly 104 in the first position.

When the grommet components 104a, 104b are rotated so that the slots and tabs 130a, 130b align, the multi-piece grommet assembly 104 assumes a radial profile enabling insertion through the second opening 122. When the grommet components 104a, 104b are rotated such that the slots and tabs 130a, 130b are out of alignment, the tab 130b projects outwardly beyond the perimeter of the opening 122 and prevents withdrawal of the multi-piece grommet assembly 104, thereby establishing a secured configuration.

The snap-fit engagement between the grommet components 104a, 104b is achieved by cooperation between an engagement ridge 702 on one component (e.g., the second grommet component 104b) and an engagement shoulder 704 (or groove) on the component (e.g., the first grommet component 104a), allowing the grommet components 104a, 104b to be pressed together during assembly while thereafter resisting axial separation. The design of the ridge, groove, and adjoining walls may include elastically deformable regions that temporarily deflect during assembly and then return to their original configuration to create a secure interlock.

The two grommet components 104a, 104b together define an annular bore 208 aligned with the center axis 116. The bore 208 may be smooth, tapered, threaded, or configured with one or more counterbore regions. The fastener 114, whether a screw, pin, bolt, or other fastening element, may be inserted through the bore 208 for securing the first component 110 to the second component 112 via the multi-piece grommet assembly 104. In some examples, the fastener 114 is a self-tapping fastener configured to form grooves in an interior surface of the annular bore 208. In other examples, the annular bore 208 can be pre-threaded. In certain embodiments, insertion and tightening of the fastener 114 may cause further rotation of the two grommet components 104a, 104b together, thereby drawing one component axially deeper relative to the other until a stop surface is reached, enhancing locking stability.

The second component may include a tool-engageable portion 206 configured to permit a user to apply torque with a tool 106, such as a screwdriver having a flat head driver 108 or similar tool, when rotating between the removal and secured configurations. A set of stop surfaces may produce tactile engagement when the components reach the secured orientation or return to the removal orientation. The tool-engageable portion 206 is accessible through the flange 128 of the first component 104a via the annular bore 208, thus making removal more accessible.

The first grommet body 104a includes a first flange 128 at its upper end, the flange 128 being configured to bear against the upper surface of a panel. The flange 128 is generally planar, though it may be formed with chamfers, radiused edges, or reinforcement ribs depending on strength and aesthetic requirements. Extending downwardly from the flange 128 is a first body portion which transitions into a first neck portion sized to pass through the opening of the panel. The external surface of the neck portion may be a generally rectangular prism (or, in some cases, cylindrical) or may include features such as flats or shallow reliefs to enhance molding efficiency. As illustrated, the rectangular prism can include rounded or chambered edges and/or corners.

The interior of the first grommet body 104a is substantially hollow, presenting an inner cylindrical surface that forms a portion of the annular bore 208. The bore 208 may widen or narrow along its length and may incorporate steps, shoulders, or lead-in chamfers facilitating receipt of the fastener 114.

During assembly, the second grommet body 104b is urged axially toward and into the first grommet body 104a such that the engagement ridge 702 deflects the first grommet body 104a and/or the second grommet body 104b until the engagement ridge 702 surpasses the engagement shoulder 704. Once the ridge enters the groove, the walls rebound and the ridge is captured, thereby preventing axial withdrawal. The surfaces may be tapered or rounded to facilitate insertion.

Both illustrated grommet components can cooperate to define a continuous central bore 208. In one embodiment, the lower part of the bore 208 within the second grommet body 104b presents a cylindrical region. The central bore 208 may include anti-rotation patterns for the fastener 114 or may be left smooth. In some examples, such as where a flush finish or shorter height is desired, a counterbore in the upper flange 128 may be configured to receive the head portion 114b.

A tool-engageable portion 206 is provided on the second grommet body 104b to allow the installer to impart rotational torque on the second grommet body 104b to move the second grommet body 104b relative to the first grommet body 104a. The tool-engageable portion 206 can be used to turn the second grommet body 104b either clockwise or counterclockwise relative to the first grommet body 104a to secure and unsecure the fastening assembly 102. This tool-engageable portion 206 may include a linear slot (whether continuous or, as illustrated, discontinuous), a cruciform (Phillips), Pozidriv, square (Robertson), Torx/star, or other drive interfaces depending on application requirements and installation tooling.

When the tool 106 is engaged, the user can rotate the second grommet body 104b relative to the first grommet body 104a, causing the multi-piece grommet assembly 104 to switch between the first position and the second position. During assembly, as the fastener 114 is driven into the fastening assembly 102 via a rotational force (as indicated by arrow 118), the second grommet body 104b rotates about the center axis 116 to ultimately assume the second position, however a tool 106 could alternatively or additionally be used with the tool-engageable portion 206 to turn the second grommet body 104b about the center axis 116 to assume the second position. Conversely, the tool 106 can be used with the tool-engageable portion 206 to turn the second grommet body 104b about the center axis 116 to return to or assume the first position. In other words, the fastening assembly 102 can assume the second position in response to the driving force of the fastener 114 (rotational force or torque about the center axis 116 resulting from, for example, the threading friction) and/or by using the tool 106 with the tool-engageable portion 206.

Stop surfaces can be integrated into the interior geometry of one or both of the first grommet body 104a and the second grommet body 104b to produce tactile feedback as the components reach either the first or second positions (i.e., the removal or secured orientations). Such stop surfaces also prevent excessive rotation and potential misalignment of the bore 208.

During installation, a user first snaps the first grommet body 104a and the second grommet body 104b together, producing the multi-piece grommet assembly 104. With reference to FIGS. 1b through 1g, the first grommet body 104a and the second grommet body 104b are rotated relative to one another to align the slots and tabs 130a, 130b. In this condition, the radial envelope of the multi-piece grommet assembly 104 (other than the flange 128) becomes small enough that the bodies 202, 210 and both the first grommet body 104a and the second grommet body 104b can be inserted through the second opening 122. Once the multi-piece grommet assembly 104 is seated in the second opening 122, the user rotates the second grommet body 104b by means of the tool-engageable portion 206. As the tab 130b moves out of alignment with the clearance, its outer edge moves beneath a portion of the surface of the second component 112. The tab 130b now extends radially beyond the second opening 122, preventing withdrawal.

In some embodiments, as the fastener 114 is inserted through the central bore 208, frictional engagement between the fastener 114 and a surface of the central bore 208 may impart additional rotational forces to the second grommet body 104b. This can produce a controlled and beneficial “cam-like” rotation, causing the tab 130b to shift further toward a locked position. The interaction between a raised locking segment on one component and an opposing wall surface on the other may produce further rotation or limit additional axial motion. The insertion of the fastener 114 may draw one component slightly farther into the other until an upper surface of the retention member engages a corresponding stop surface, thereby creating a secure and stable interface.

The multi-piece grommet assembly 104 may be partially removed by reversing the process. The fastener 114, if present, is extracted, and torque is applied to the second grommet body 104b to rotate the components back into the removal configuration. Once the retention member again aligns with the clearance, the multi-piece grommet assembly 104 is ready to be withdrawn axially from the panel opening. To release the snaps 126, a tool (e.g., the tool 106, or a portion thereof) can be inserted into one or more access slots 204 formed in the flange 128. The access slots 204 are configured and/or aligned to enable a user to engage, manipulate, and collapse the snaps 126 via the tool 106 to release and remove the multi-piece grommet assembly 104 from the second component 112 as indicated by arrow 402.

With reference to FIG. 3, an example tool 106 can include a shank 132 with an alignment post 302 and a pair of spaced-apart, parallel pins 304. The shank 132 can have a hexagonal cross section and be configured to be driven by a power tool. For example, the end of the shank 132 may be configured to engage a power tool chuck via a quick release mechanism. The alignment post 302 is configured to insert into the central bore 208 (after the fastener 114 is removed), while the pair of pins 304 are configured to align with and pass through the access slots 204 to enable a user to engage, manipulate, and collapse the snaps 126. With reference to FIG. 4d, the distal ends of the pins 304 abut the engagement surface 126a of the snaps 126 to cause them to flex inward, toward the center axis 116 as indicated by arrows 404, thus enabling the snaps 126 (and thus, the multi-piece grommet assembly 104) to clear the second opening 122 for removal in the direction of arrow 402.

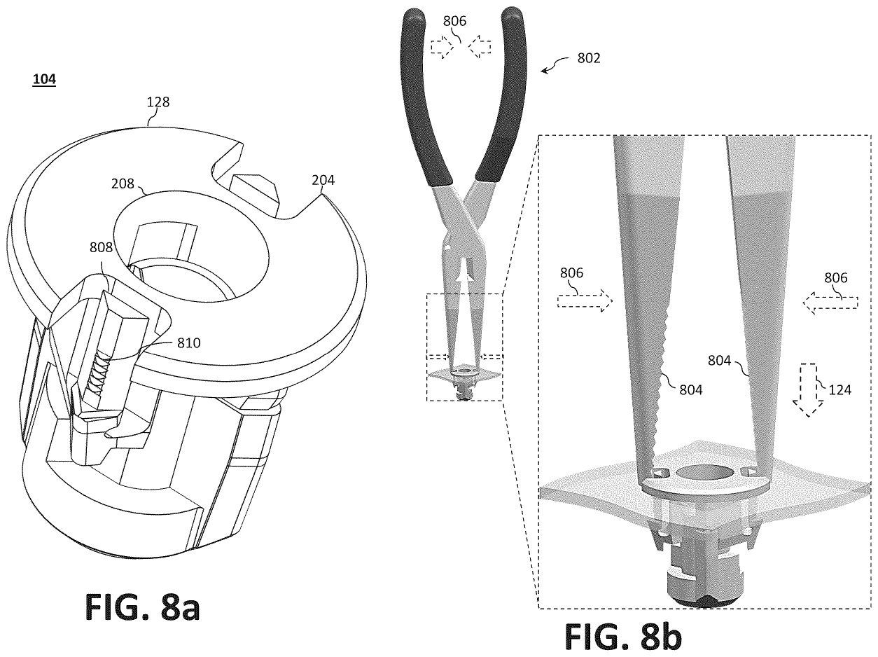

FIGS. 8a and 8b illustrate an assembled fastening assembly 102 in accordance with another aspect of this disclosure. In these views, the fastening assembly 102 incorporates the same fundamental structure, components, features, and operational principles as previously described for the fastening assembly 102 shown in FIGS. 1a-7h except as explicitly indicated. The multi-piece grommet assembly 104 shown in FIGS. 8a and 8b includes the first grommet body 104a and the second grommet body 104b arranged in the same snap-fit, axially fixed, rotatable relationship, and the transition between the unlocked and locked positions is achieved through the same alignment and misalignment of the slots 130a and tabs 130b. The retaining snaps 126, the flange 128, the body portions 202 and 210, and the bore 208 remain structurally and functionally consistent with the earlier described embodiment. The fastening assembly 102 of FIGS. 8a and 8b therefore operates according to the same installation, locking, unlocking, and removal procedures previously described, using the fastener 114 and the rotational sequence.

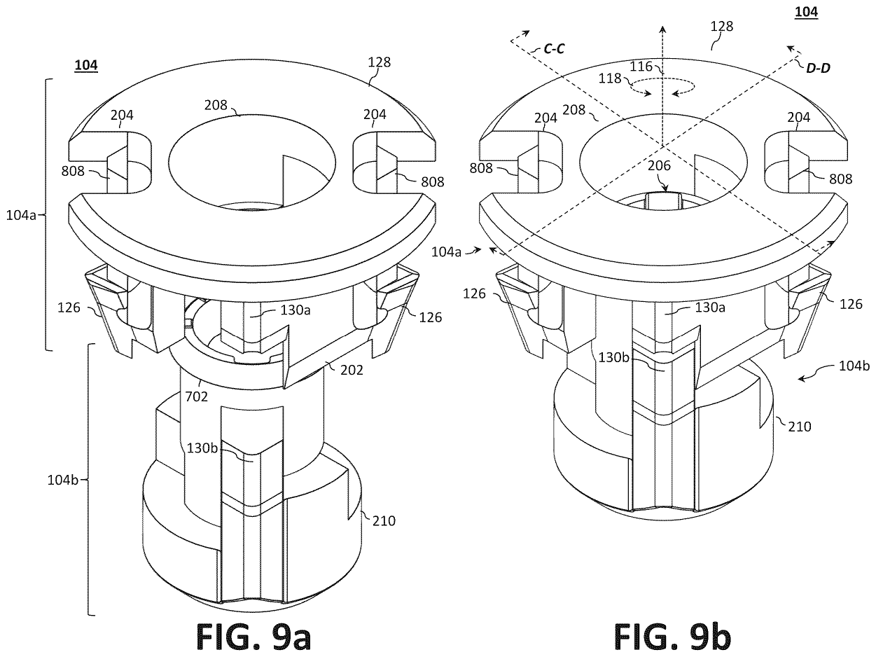

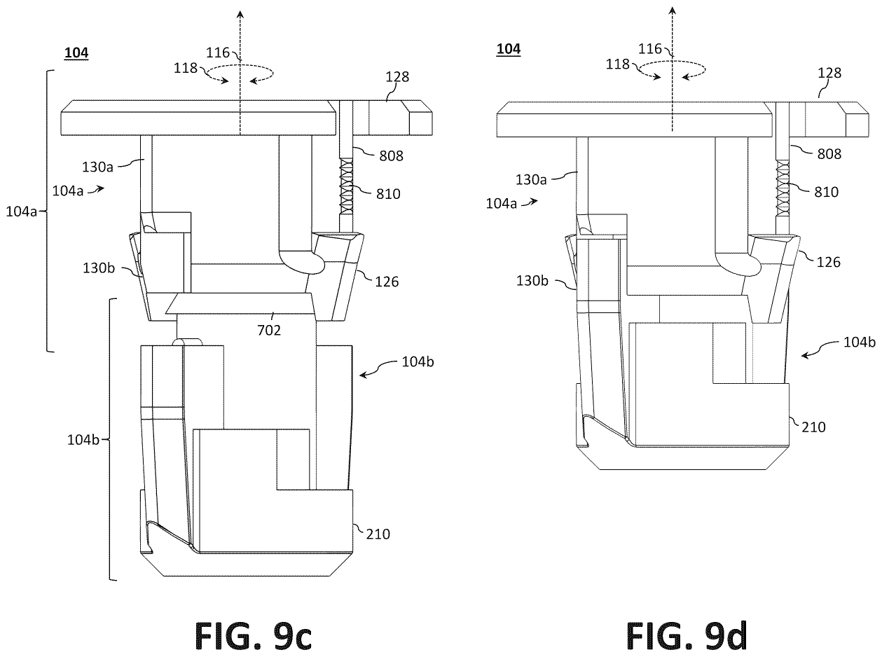

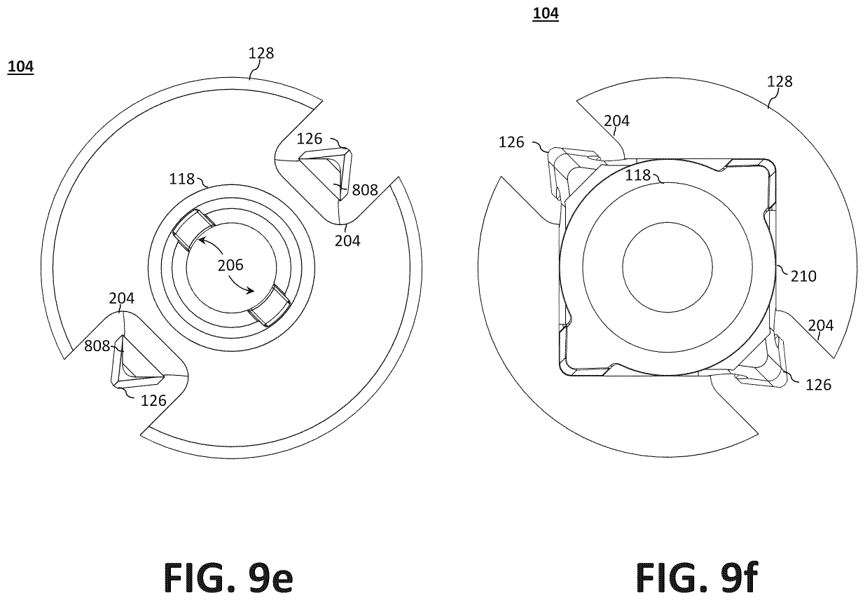

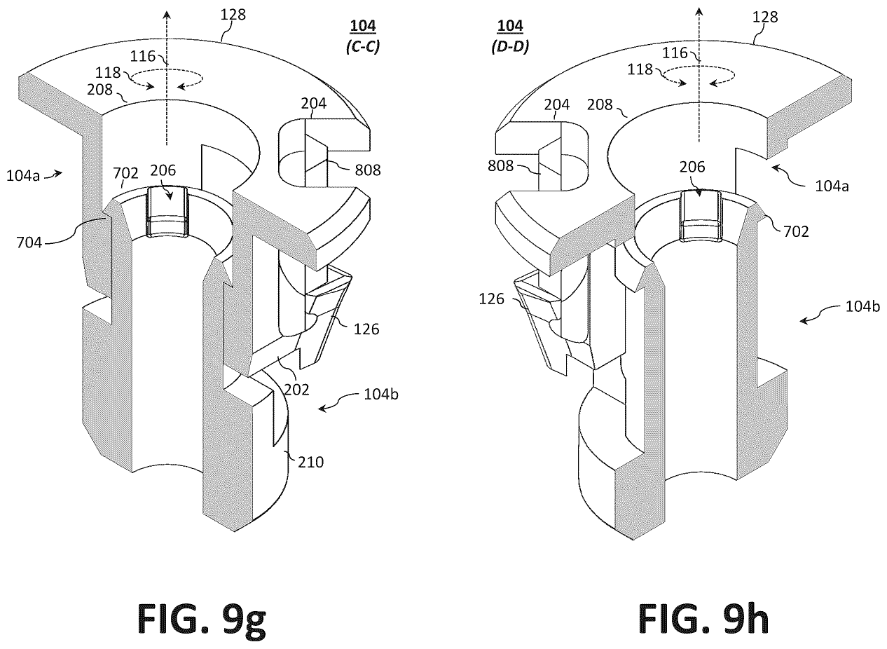

FIGS. 9a through 9h illustrate another embodiment of the multi-piece grommet assembly 104 that is similar in construction and function to the multi-piece grommet assembly 104 shown in FIGS. 7a through 7h. Unless specifically stated otherwise, all features are identical in form, function, and material options to the earlier-described embodiment, such as the first grommet body 104a, the second grommet body 104b, the flange 128, the retaining snaps 126, the slots 130a, the tabs 130b, the engagement ridge 702, the engagement shoulder 704, the annular bore 208, the tool-engageable portion 206, and the rotational locking mechanism. The principal variation in the embodiment of FIGS. 9a through 9h lies in the design of the access slots 204 and the inclusion of grip tabs 808. In this embodiment, the access slots 204 include an open lateral edge to permit insertion of a jaw 804 (or plural jaws 804) of a pair of needle-nose pliers 802 used as the tool 106. This lateral insertion path enables a user to apply inward squeezing forces (arrows 806) directly to the retaining snaps 126 without requiring a vertically inserting tool such as the alignment post 302 and pins 304 of the prior tool 106.

The grip tabs 808 extend upwardly from the retaining snaps 126 toward or into the access slots 204 and provide a positive engagement interface for the jaws 804 of the needle-nose pliers 802. The grip tabs 808 may include a textured portion 810, such as raised ridges, knurling, or molded friction-enhancing patterns, which increase friction between the jaws 804 and the retaining snaps 126 during compression. This textured portion 810 reduces slippage, enables more controlled manipulation of the retaining snaps 126, and facilitates collapsing the snaps 126 to release the multi-piece grommet assembly 104 from the second component 112. The remainder of the functionality—including insertion through the second opening 122, rotation between unlocked and locked positions, and retention of the second component 112 between the snaps 126 and the underside of the flange 128—remains the same as the earlier embodiment. Thus, the embodiment of FIGS. 9a-9h differs primarily in the tool interface mechanism, while all other features not expressly described as different are identical or functionally equivalent to the previously described multi-piece grommet assembly 104.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A multi-piece grommet assembly for securing a first component to a second component, comprising:
a first grommet body comprising a flange configured to abut a surface of the second component and a first body portion extending axially from the flange;
a second grommet body comprising a second body portion configured for snap-fit engagement with the first grommet body,
wherein the first and second grommet bodies are rotatable relative to one another about a center axis between a first position and a second position;
a plurality of slots disposed on the first grommet body and a plurality of tabs disposed on the second grommet body,
wherein the slots and tabs align in the first position and are misaligned in the second position to prevent axial removal of the multi-piece grommet assembly;
one or more retaining snaps extending outwardly from the first body portion and configured to engage the second component; and
a bore extending through the first and second grommet bodies along the center axis, the bore configured to receive a fastener to secure the first component to the second component.

2. The multi-piece grommet assembly of claim 1, wherein the first and second grommet bodies are axially fixed and snap-fit together via an engagement ridge on one grommet body cooperating with an engagement shoulder on the other grommet body.

3. The multi-piece grommet assembly of claim 1, wherein the first grommet body further comprises a plurality of access slots formed in the flange, the access slots configured to receive a tool to collapse the retaining snaps.

4. The multi-piece grommet assembly of claim 3, further comprising grip tabs extending from the retaining snaps toward or into the access slots, the grip tabs configured to provide a positive engagement interface with jaws of a plier-type tool.

5. The multi-piece grommet assembly of claim 4, wherein the grip tabs include a textured portion configured to increase friction between the tool and the retaining snaps during manipulation.

6. The multi-piece grommet assembly of claim 1, wherein the slots and tabs engage via an interference fit in the first position to reduce unwanted rotation between the grommet bodies.

7. The multi-piece grommet assembly of claim 1, wherein the bore comprises a counterbore portion configured to at least partially receive a head portion of the fastener.

8. The multi-piece grommet assembly of claim 1, wherein the first and second grommet bodies are formed of a polymeric material.

9. The multi-piece grommet assembly of claim 8, wherein the polymeric material is a polypropylene, polyethylene, polycarbonate, acrylonitrile butadiene styrene, polyamide, polyoxymethylene, thermoplastic elastomer, or thermoset material.

10. The multi-piece grommet assembly of claim 1, wherein the first and second grommet bodies are injection-molded.

11. The multi-piece grommet assembly of claim 1, wherein the first grommet body and the second grommet body are molded as a single component and are connected to one another by at least one flash-gate connection formed during an injection-molding process.

12. The grommet assembly of claim 11, wherein the at least one flash-gate connection is configured to break upon application of an axial compressive force to separate the first grommet body and the second grommet body and ultimately assume the snap-fit engagement.

13. The multi-piece grommet assembly of claim 1, wherein the first grommet body and the second grommet body are molded as a single component and are connected to one another by a plurality of flash-gate connection circumferentially spaced around an interface between the first grommet body and the second grommet body.

14. A multi-piece grommet assembly for securing a first component to a second component, comprising:
a first grommet body comprising a flange and a first body portion;
a second grommet body comprising a second body portion configured for snap-fit engagement with the first grommet body; and
a tool-engageable portion on the second grommet body, the tool-engageable portion configured to receive a torque-applying tool to rotate the second grommet body relative to the first grommet body between a first position and a second position,
wherein rotation of the second grommet body causes detents on the second grommet body to move between alignment with detents on the first grommet body in the first position to allow axial removal of the multi-piece grommet assembly and a misalignment with detents on the first grommet body in the second position to prevent axial removal of the multi-piece grommet assembly.

15. The multi-piece grommet assembly of claim 14, wherein the tool-engageable portion comprises a linear slot, cruciform slot, square slot, Torx/star slot, or other drive interface.

16. The multi-piece grommet assembly of claim 14, wherein the bore extends through the first and second grommet bodies and is configured to receive a fastener to secure the first component to the second component.

17. The multi-piece grommet assembly of claim 14, wherein the first and second grommet bodies are axially fixed and snap-fit together via an engagement ridge and engagement shoulder.

18. The multi-piece grommet assembly of claim 14, wherein the first grommet body and the second grommet body are molded as a single component and are connected to one another by at least one flash-gate connection formed during an injection-molding process.

19. A multi-piece grommet assembly for securing a first component to a second component, comprising:
a first grommet body comprising a flange with one or more access slots;
a second grommet body configured for snap-fit engagement with the first grommet body;
one or more retaining snaps extending from the first grommet body toward the second component; and
grip tabs extending upwardly from the retaining snaps toward or into the access slots, the grip tabs including a textured portion configured to engage a jaw of a plier-type tool inserted laterally into the access slots, such that the retaining snaps can be collapsed to permit removal of the multi-piece grommet assembly.

20. The multi-piece grommet assembly of claim 19, wherein the grip tabs comprise raised ridges, knurling, or molded friction-enhancing patterns.
